(19) United States
(12) Patent Application Publication
(10) Pub. No.: US 2014/0162753 A1
(43) Pub. Date: Jun. 12, 2014

(54) SYSTEM AND METHOD FOR OPTIMIZING A WINNINGS VALUE OF A GAMING DEVICE

(71) Applicant: Net Entertainment NE AB, Stockholm (SE)

(72) Inventors: Andreas Bexelius, Stockholm (SE); Fredrik Hård af Segerstad, Stockholm (SE); Andre Nylander, Stockholm (SE); Ola Öinert, Malmo (SE); Christer Hutchinson-Kay, Taby (SE)

(73) Assignee: Net Entertainment NE AB, Stockholm (SE)

(21) Appl. No.: 14/013,119

(22) Filed: Aug. 29, 2013

Related U.S. Application Data
(60) Provisional application No. 61/732,999, filed on Dec. 4, 2012.

(51) Int. Cl. G07F 17/34

(52) U.S. Cl. CPC G07F 17/34
USPC 463/20

(57) ABSTRACT

A system and method for optimizing the winnings value of a slot machine or other gaming device, comprising: obtaining 100 a coin value from memory 216, generating 130 a first result, generating 140 a second result as a single value result, determining 150 an updated array comprising M values and assigning said arrays first value with said single value result and determining 160 a winnings value based on said coin value, said first result and said updated array.

### TECHNICAL FIELD

Generally, embodiments of the invention relate to the technical field of casino games.

More specifically, different embodiments of the application relate to optimizing the winnings value of a casino game, such as a slot machine.

### BACKGROUND

In general casino games and casino gaming relate to operating a casino device where a bet is placed, a user input is made, a result is generated and a winnings value is determined based on the generated result.

Such games are sometimes referred to as slot machine, fruit machine, the slots, poker machine, slot or one-armed bandits

In some prior art solutions the winnings value is determined immediately after the result is generated resulting in a static game user experience and a non-optimal combination of the gaming result.

Therefore the inventor has identified a need for an enhanced game user experience and an improved gaming result, e.g. in the form of a bonus game triggered after a generated first result. In particular a bonus game resulting in a temporal dependent winnings value that is dependent on successive game rounds.

These and other considerations have been addressed by the current invention that is described more fully below in the description. Additional benefits and advantages of the current invention will be given below or will be apparent from the nature of the invention.

### RELATED ART

An example of related art is found in the following document:

US20070010317 A1

However, the related art does not disclose the solutions of the present invention.

### SUMMARY

In prior art solution the winnings value is determined immediately after the result is generated resulting in a static game user experience and a non-optimal combination of the gaming result.

Therefore the inventor has identified a need for an enhanced game user experience and an improved gaming result, e.g. in the form of a bonus game.

In one or more embodiments a method for optimizing the final winnings value of an enhanced slot machine, comprising:
obtaining 100 a coin value from memory 216
generating 130 a first result,
generating 140 a second result as a single value result,
determining 150 an updated array comprising M values and assigning said arrays first value with said single value result,
determining 160 a winnings value based on said coin value, said first result and said updated array

In one or more embodiments the method further comprises:
obtaining 110 the available latest previous successive results of the second result generator from memory 216 as an ordered array of length M, wherein said array is ordered with the most recent value first and the Mth value last,
shifting 120 values of the obtained array one step, thereby discarding the Mth value,
   , wherein said first result comprises result values 310 arranged in an N rows 320 by M columns 330 original matrix 300 of cells,

In one or more embodiments, wherein obtaining a coin value further comprises:
determining that the obtained coin value is different than in the previous game round and clearing the values of previous successive results of the second result generator from memory.

In one or more embodiments, wherein determining a winnings value further comprises:
determine that a bonus game should be performed based on said first result and said updated array, wherein determine that a bonus game should be performed is based on the comparison of each value of said updated array to values in an associated column of said first result, wherein said association is exclusive and one to one; and;
if it is determined that a bonus game should be performed then perform a bonus game; else;
   determine a winnings value based on said first result. In one or more embodiments a, wherein performing a bonus game comprises:
determine that said value of said updated array equals a predetermined coin win value;
determine that at least one of said values in an associated column of said first result equals a predetermined wild value; and
determine a winnings value as a sum of said original winnings value and a predetermined winnings value associated to said coin win value.

In one or more embodiments, wherein performing a bonus game comprises:
store said current first result and said current updated array to memory 216 as an original result;
determine that said value of said updated array equals a predetermined free spin value;
determine that at least one of said values in an associated column of said first result equals a predetermined wild value;
successively perform the method steps of obtaining a coin value from memory 216, obtaining the latest previous successive results of the second result generator from memory 216 as an ordered array of length M, shifting values of the obtained array one step, generating a first result, generating a second result as a single value result, determining an updated array by updating said obtained and shifted arrays first value with said single value result and determining a winnings value based on said coin value, said first result and said updated array and determining a winnings value based on said coin value, said first result and said updated array a predetermined number of times;
determine a winnings value as the sum of said original winnings value and said successively determined winnings values; and;
restore the current result by retrieving said original result from memory.

In one or more embodiments, wherein performing a bonus game comprises:
determine that said value of said updated array equals a predetermined swapping symbols value;
identify a position 340 in said first result, wherein at least one of said values in an associated column of said first result equals a predetermined wild value;
determine a subset of adjacent cells 410 as being adjacent to said identified position in said first result and to determine all possible cell pairs within said subset; and for each of said possible cell pairs:
determine a modified matrix, wherein the position of the values of the two cells comprised in the cell pair is swapped compared to their positions in the original matrix;
determine a winnings value for said cell pair as a function of the values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
if the maximum winnings value is greater than zero,
set the final winnings value of the slot machine result to the maximum winnings value; else;
repeat the previous method steps of claims 1, 4 and 7

In one or more embodiments, wherein performing a bonus game comprises:

In one or more embodiments, wherein performing a bonus game comprises:
determine that said value of said updated array equals a predetermined spreading wilds value
identify a position 340 in said first result, wherein at least one of said values in an associated column of said first result equals a predetermined wild value;
determine a subset of adjacent cells 410 as being adjacent to said identified position in said first result
setting the value of said subset of adjacent cells 410 to said predetermined wild symbol value to obtain a modified first result;
determine a winnings value based on said modified first result.

In one or more embodiments, wherein performing a bonus game comprises:
determine that said value of said updated array equals a predetermined changing symbols value;
identify a position 340 in said first result, wherein at least one of said values in an associated column of said first result equals a predetermined wild value.
determining an original winnings value based on the values of said first result;
determine a subset of adjacent cells 410 as being adjacent to said identified position in said first result and determine all possible permutations within said subset; and for each of said possible permutations,
   determine a modified matrix, wherein the permutated values of the cells comprised in subset of adjacent cells is changed compared to their positions in the original matrix,
   determine a winnings value based on said modified matrix;
comparing all determined winnings values, wherein all determined winnings values include the original winnings value and the winnings values determined for each modified matrix; select a winnings value from said comparison of all winnings values; determining whether the selected winnings value is greater than zero; and
   if the selected winnings value is greater than zero, set the final winnings value of the slot machine result to the winnings value;

In one or more embodiments, wherein performing a bonus game comprises:
determine that said value of said updated array equals a predetermined surprise win value;
determine that at least one of said values in an associated column of said first result equals a predetermined wild value;
determine a winnings value by randomly performing a selection of one of the set of steps comprised in embodiments described herein.

In one or more embodiments a System for optimizing the final winnings value of an enhanced slot machine, comprising:
a game controller 212, e.g. a processor or processing unit;
a first result generator 219
a memory 216 adapted to store and retrieve program code portions, parameters and historical or previous results of the second result generator
a communications interface 217 configured to send or receive data values or parameters to/from a game controller 212 to/from external units via the communications interface 217;
a winnings value generator 221 adapted to determine a result based on a parameter describing a betting value and the result of the first result generator;
a user input/output device 215 adapted to receive data as a signal from the game controller 212 and display a representation of said data and to receive user indications as data and send said indications as a signal to the game controller 212;
   wherein said game controller 212 is provided with specifically designed programming or program code portions adapted to control the processing unit to perform the method steps of claims 1-8

In one or more embodiments, wherein said first result generator 219 is adapted to generate a multidimensional value (M columns and N rows) slot machine result and said second result generator 220 adapted to generate a single value result.

In one or more embodiments, wherein result for the M previous results of the second result generator is stored in memory 216.

In one or more embodiments, wherein said winnings value generator 221 is further adapted to determine a winnings value based on the result of the second result generator.

In one or more embodiments, wherein said winnings value generator 221 may be an integral part of the game controller 212, external to the game controller inside the system or external to the system and communicating via an external communications interface with the game controller 212.

In one or more embodiments, wherein said game controller 212 is communicatively coupled to said user input/output device 215, said memory 216, communications interface 217, said first result generator 219 and said second result generator 220;

In accordance with embodiments described herein, the identified needs are met by providing an enhanced gaming experience to a game user, or player, and/or to provide an improved gaming result or optimized winnings value. In particular achieving a temporal dependent winnings value that is dependent on successive game rounds

In accordance with embodiments, the winnings value is optimized by adapting the generated result based on predefined conditions, functions, logic or rules.

### BRIEF DESCRIPTION OF DRAWINGS

Embodiments of the invention will now be described in more detail with reference to the appended drawings, wherein:

FIG. 1 shows a flow diagram of method embodiments wherein an optimized winnings value is generated.

FIG. 2 shows a schematic view of a system embodiment.

FIG. 3 shows an embodiment of a result matrix.

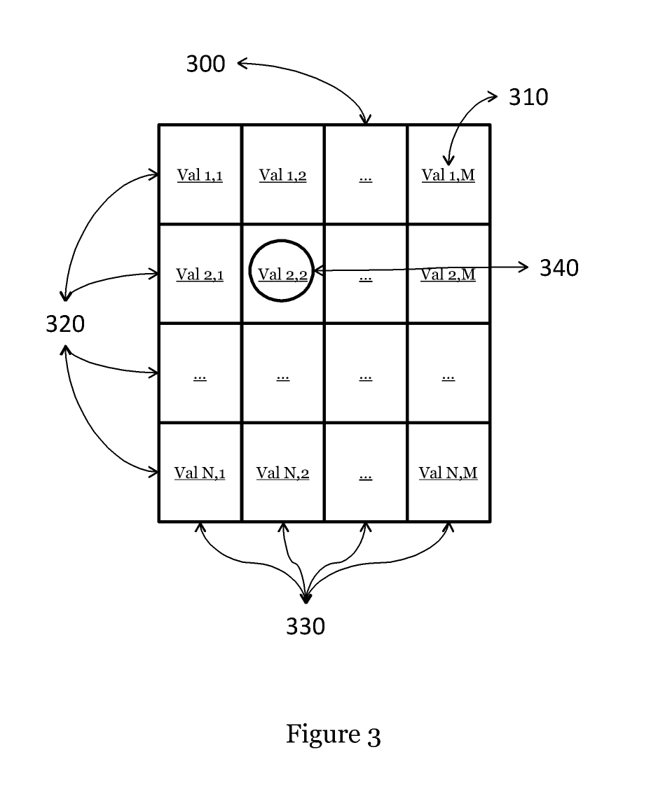

FIG. 4 shows examples of identified adjacent cells.

FIG. 5 shows an example embodiment of a gaming device

FIG. 6 shows a schematic view of a system embodiment

### DETAILED DESCRIPTION

A general embodiment of a system and method for determining a winnings value according to the inventive concept is realized as a system and method for enabling an enhanced, or optimized, game result.

### Background on Slot Machine Type Games

As mentioned previously general casino games and casino gaming relate to operating a casino device where a bet is placed, a user input is made, a result is generated and a winnings value is determined based on the generated result. In particular, the invention relates to games that are sometimes referred to as slot machine, fruit machine, the slots, poker machine, slot or one-armed bandits.

Casino games might be performed on any computing device comprising a game controller, such as a processor in a smartphone, personal digital assistant (PDA), tablet personal computer, pocket personal computer, notebook computer, desktop computer, server computer, and the like.

Conventionally when playing a slot machine type game a user first selects a betting or coin value, activates the game, e.g. spin the reels of a slot machine, and is presented with a first result and a winnings value based on said first result, typically by evaluation of the result along one or a plurality predefined lines linking the values of the result or the presented symbols, also referred to as paylines, as would be understood by a person skilled in the art. The result might be generated by a first result generator which is in turn may be evaluated by a winnings value generator and presented to the game user via a user input/output device 215.

Determining a winnings value solely based on said pre-determined combination of said first result values might lead to a static game experience.

To further enhance the game experience a bonus game might be triggered when certain first result values are obtained. Thereby the bonus game is activated and a secondary evaluation of the winnings value by a winnings value generator is performed. The inventor has realized that the gaming experience can be further improved by combining a said first result with historical values of a second result, e.g. M latest second results. Thereby a multi generator, several result generators, temporal dependent winnings value can be obtained which is dependent on successive game rounds.

### System Architecture

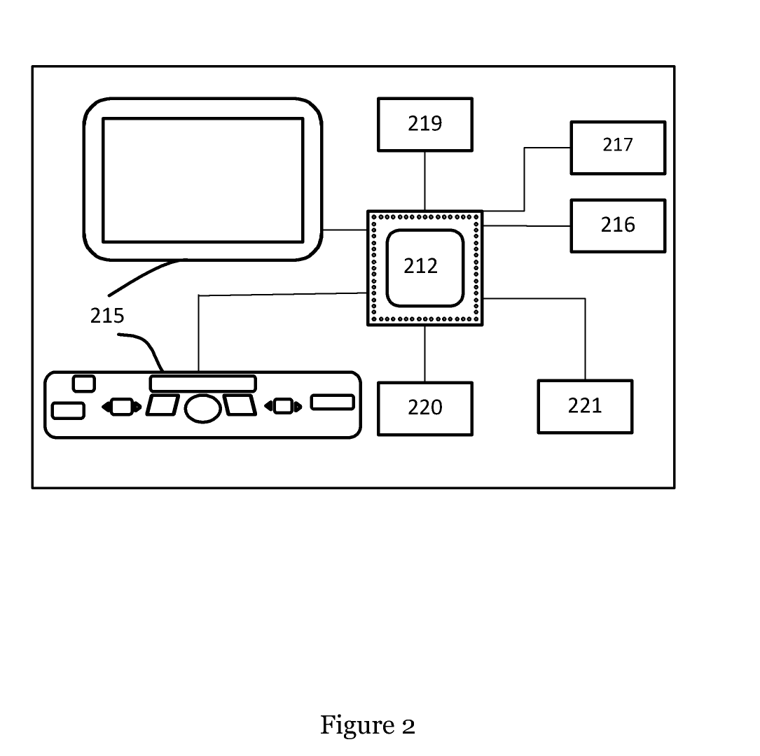

In FIG. 2, a schematic view of a system embodiment for optimizing the final winnings value of an enhanced slot machine is shown. The system comprises, in accordance with different embodiments presented herein a game controller 212, e.g. a processor or processing unit provided with specifically designed programming or program code portions adapted to control the processing unit to perform one or more embodiments of the inventive method described herein. The system further comprises a first result generator 219 adapted to generate a multidimensional value (M columns and N rows) slot machine result and a second result generator 220 adapted to generate a single value result. The result for the M previous results of the second result generator may be stored in a memory 216. The system further comprises a memory 216 adapted to store and retrieve program code portions, parameters and historical or previous results of the second result generator. Said program code portions may be adapted to control the processing unit to perform various embodiments of the methods described further herein. Said parameters may be adapted to store values that are to be used as input for various tasks, such as determining a winnings value or any other operation that may utilize parameters, such as setting or retrieving betting or coin value. The system further comprises a communications interface 217 configured to send or receive data values or parameters to/from a game controller 212 to/from external units via the communications interface 217. The system further comprises a winnings value generator 221 adapted to determine a winnings value based on a parameter describing a betting value and the result of the first result generator. In an alternative embodiment said winnings value generator 221 is adapted to determine a winnings value based on a parameter describing a betting value, the result of the first result generator and the result of the second result generator. Said winnings value generator 221 may be an integral part of the game controller 212, external to the game controller inside the system or external to the system and communicating via an external communications interface with the game controller 212. The system further comprises a user input/output device 215 adapted to receive data as a signal from the game controller 212 and display a representation of said data. Said user input/output device 215 is further adapted to receive user indications as data and send said indications as a signal to the game controller 212. Said user input/output device 215 may be a graphical user interface with touch functionality. The game controller 212 is communicatively coupled to said user input/output device 215, said memory 216, communications interface 217, said first result generator 219 and said second result generator 220. In one or more embodiments said game controller 212 is further communicatively coupled to said winnings value generator 221.

In one or more embodiments, said system is a video slot machine system.

According to one or more embodiments, a non-transitory computer-readable medium may be provided, wherein the computer-readable medium on which is stored instructions which, when executed by a processor/processing unit, non-transitory information adapted to controls the processor/processing unit to perform any of the methods for optimizing the final winnings value of an enhanced slot machine described herein.

In one or more embodiments, a computer program product may be provided that comprising code portions adapted to control a processor to perform any of the methods for optimizing the final winnings value of an enhanced slot machine described herein.

### Method Embodiments

In one or more embodiments of the invention a method for a game controller to optimize the winnings value of an enhanced gaming device, e.g. a slot machine, comprises:
obtaining 100 a coin value from memory 216
generating 130 a first result, wherein the first result comprises result values 310 arranged in an N rows 320 by M columns 330 original matrix 300 of cells,
generating 140 a second result as a single value result,
determining 150 an updated array comprising M values by updating said updated arrays first value with said single value result,
determining 160 a winnings value based on said coin value, said first result and said updated array

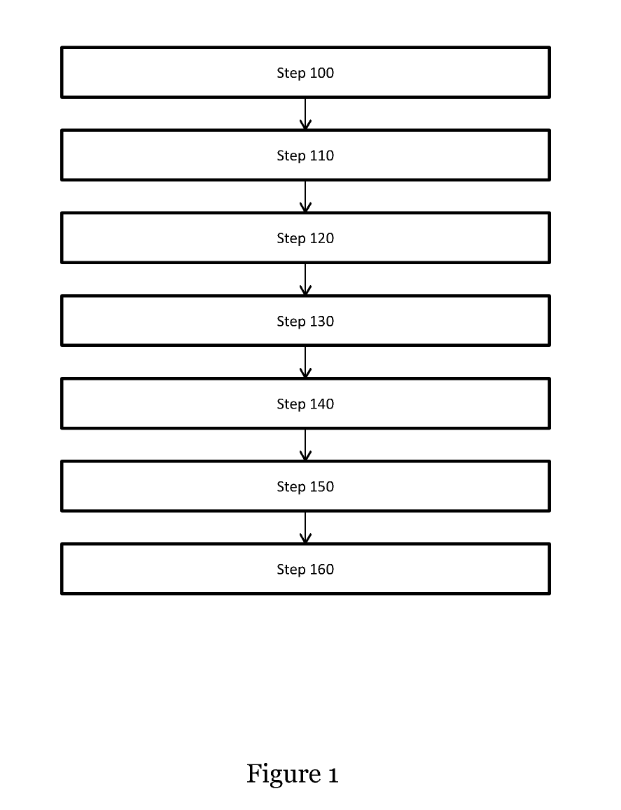

FIG. 1 shows a flow diagram of method embodiments wherein an optimized winnings value is generated.

In one or more embodiments of the invention a method for a game controller to optimize the winnings value of an enhanced gaming device, e.g. a slot machine, comprises:
obtaining 100 a coin value from memory 216
obtaining 110 the available latest previous successive results of the second result generator from memory 216 as an ordered array of length M, wherein said array is ordered with the most recent value first and the Mth value last,
shifting 120 values of the obtained array one step, thereby discarding the Mth value,
generating 130 a first result, wherein the result comprises result values 310 arranged in an N rows 320 by M columns 330 original matrix 300 of cells,
generating 140 a second result as a single value result,
determining 150 an updated array by updating said obtained and shifted arrays first value with said single value result,
determining 160 a winnings value based on said coin value, said first result and said updated array

In one or more embodiments, wherein obtaining a coin value further comprises:
determining that the obtained coin value is different than in the previous game round and clearing the values of previous successive results of the second result generator in said updated array from memory.

In one or more embodiments, determining a winnings value further comprises:
determine that a bonus game should be performed based on said first result and said updated array, wherein determine that a bonus game should be performed is based on the comparison of each value of said updated array to values in an associated column of said first result, wherein said association is exclusive and one to one,
determine an original winnings value based on said first result.
if it is determined that a bonus game should be performed then perform a bonus game;

### Coin Win

In one or more embodiments, wherein performing a bonus game comprises:
determine that said value of said updated array equals a predetermined coin win value
determine that at least one of said values in an associated column of said first result equals a predetermined wild value.
determine a winnings value as a sum of said original winnings value and a predetermined winnings value associated to said coin win value.

In one or more embodiments, wherein said predetermined coin win value is represented as a parameter in memory 216.

### Free Spin

In one or more embodiments, wherein performing a bonus game comprises:
store said current first result and said current updated array to memory 216 as an original result.
determine that said value of said updated array equals a predetermined free spin win value
determine that at least one of said values in an associated column of said first result equals a predetermined wild value.
successively perform the method steps of obtaining a coin value from memory 216, obtaining the latest previous successive results of the second result generator from memory 216 as an ordered array of length M, shifting values of the obtained array one step, generating a first result, generating a second result as a single value result, determining an updated array by updating said obtained and shifted arrays first value with said single value result and determining a winnings value based on said coin value, said first result and said updated array and determining a winnings value based on said coin value, said first result and said updated array;
   a predetermined number of times.
determine a winnings value as the sum of said original winnings value and said successively determined winnings values
restore the current result by retrieving said original result from memory.

In one or more embodiments, wherein said predetermined free spin win value is represented as a parameter in memory 216.

### Spreading Wilds

In one or more embodiments, wherein performing a bonus game comprises:
determine that said value of said updated array equals a predetermined spreading wilds value
identify a position 340 in said first result, wherein at least one of said values in an associated column of said first result equals a predetermined wild value;
determine a subset of adjacent cells 410 as being adjacent to said identified position in said first result and setting the value of said subset of adjacent cells 410 to said predetermined wild value to obtain a modified first result;
determine a winnings value based on said modified first result.

In one or more embodiments, wherein said predetermined spreading wilds win value is represented as a parameter in memory 216.

### Swapping Symbols

In one or more embodiments, wherein performing a bonus game comprises:
determine that said value of said updated array equals a predetermined swapping symbols value;
identify a position 340 in said first result, wherein at least one of said values in an associated column of said first result equals a predetermined wild value.
determine a subset of adjacent cells 410 as being adjacent to said identified position in said first result and to determine all possible cell pairs within said subset; and for each of said possible cell pairs:
   determine a modified matrix, wherein the position of the values of the two cells comprised in the cell pair is swapped compared to their positions in the original matrix;
   determine a winnings value as a sum of said original winnings value and a winnings value for said cell pair as a function of the values of said modified matrix;
comparing all determined winnings values, wherein all determined winnings values include the original winnings value and the winnings values determined for each modified matrix; determining a maximum winnings value corresponding to the highest winnings value from said comparison of all winnings values; determining whether the maximum winnings value is greater than zero; and
   if the maximum winnings value is greater than zero, set the final winnings value of the slot machine result to the maximum winnings value;
   if the maximum winnings value is not greater than zero, repeat the previous method steps.

In one or more embodiments, wherein said predetermined swapping symbols win value is represented as a parameter in memory 216.

### Changing Symbols

In one or more embodiments, wherein performing a bonus game comprises:
determine that said value of said updated array equals a predetermined changing symbols value;
identify a position 340 in said first result, wherein at least one of said values in an associated column of said first result equals a predetermined wild value.
determining an original winnings value based on the values of said first result;
determine a subset of adjacent cells 410 as being adjacent to said identified position in said first result and to determine all possible permutations within said subset; and for each of said possible permutation:
   determine a modified matrix, wherein the permutated values of the cells comprised in subset of adjacent cells is changed compared to their positions in the original matrix;
   determine a winnings value based on said modified matrix;
comparing all determined winnings values, wherein all determined winnings values include the original winnings value and the winnings values determined for each modified matrix; select a winnings value from said comparison of all winnings values; determining whether the selected winnings value is greater than zero; and
   if the selected winnings value is greater than zero, set the final winnings value of the slot machine result to the winnings value;

In one or more embodiments, wherein said predetermined changing symbols win value is represented as a parameter in memory 216.

### Surprise Win

In one or more embodiments, wherein performing a bonus game comprises:
determine that said value of said updated array equals a predetermined surprise win value
determine that at least one of said values in an associated column of said first result equals a predetermined wild value.
determine a winnings value by randomly selecting one of the embodiments described above.

In one or more embodiments, wherein said predetermined surprise win value is represented as a parameter in memory 216.

### Winnings Value Generator

In accordance with an embodiment, the winnings generator 221 is configured to obtain said first result from a said game controller 212, to determine the winnings value, based on said received first result and said coin value. In other words, determination or calculation of the winnings value may be performed by winnings generator 221 logic comprised in the game controller 212, a specific winnings value generator 221 or in an external node communicatively coupled to said communications interface 217. Such a winnings value generator may be integrated in, connected to or communicatively coupled to the game controller 212. Said winnings generator 221 may interpret a wild value as a generic value, wherein said generic symbol may represent any value that may be generated by said first result generator.

In one example said winnings generator 221 interprets the first result along a payline, e.g. [value 1, value 1, value 1, value 1, wild value] as a result of as a series of five value 1.

### First Result Generator

In accordance with an embodiment, the first result generator 219 is configured to send a generated first result to said game controller 212. In other words, determination or calculation of the first result may be performed by logic comprised in the game controller, in an optional specific first result generator 219 or in an external node communicatively coupled to said communications interface 217. Such a first result generator may be integrated in, connected to or communicatively coupled to the game controller 212.

### Second Result Generator

In accordance with an embodiment, the second result generator 220 is configured to send said second result to said game controller 212. In other words, determination or calculation of the second result may be performed by logic comprised in the game controller, in an optional specific second result generator 220 or in an external node communicatively coupled to said communications interface 217. Such a second result generator may be integrated in, connected to or communicatively coupled to the game controller 212.

In one or more embodiments said user input/output device 215 comprises a graphical game user adapted generate a graphical representation of the steps described above of generating a first result, generating a second result as a single value result, determining an updated array by updating said obtained and shifted arrays first value with said single value result and determining a winnings value or any other step performed by the system.

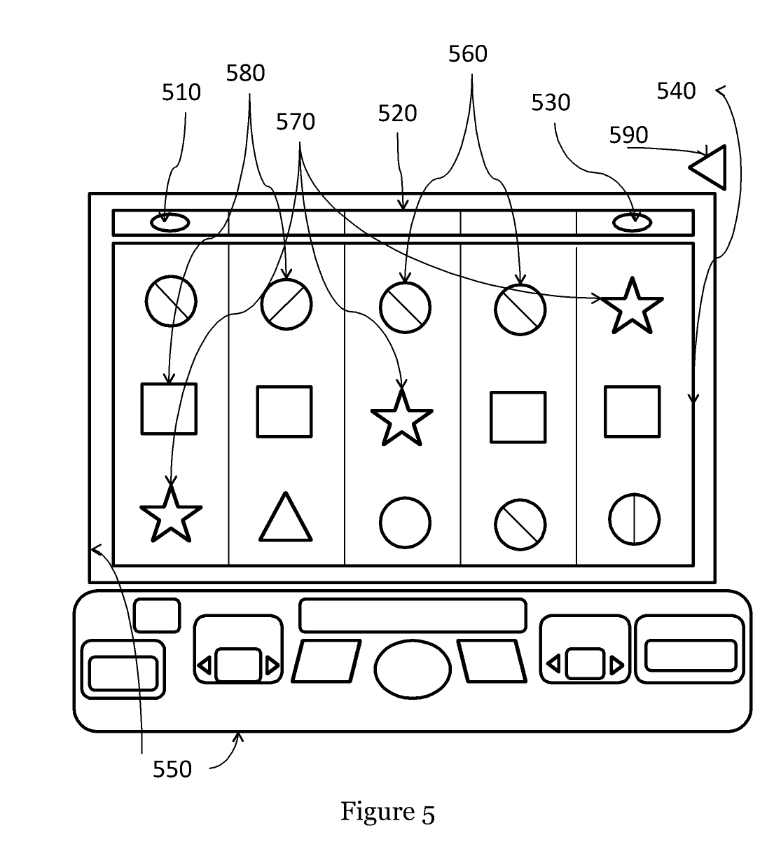

FIG. 5 shows an example embodiment of a gaming device. In one example embodiment the casino game is a 5×3 video slot machine 540, but with an extra row above the reels featuring a conveyor belt 520. The game may have a fixed number or dynamically changeable number of paylines.

The first result generator 219 generates a result matrix with M columns comprising a selection of 5 low win values, 5 medium win values and one wild value. The user input/output device 215 receives said values as a signal from the game controller 212 translates and presents said values as low win symbols 560, medium win symbols 580 and one wild symbol 570 presented in the slot reel area 540.

The main feature of the base game is the egg Conveyor Belt 520, that acts as a memory preserving previous historical results of the second result generator, said previous historical results are stored as values in an ordered array in the memory 216. The values represented in the graphical user interface of the user input/output device 215 are ordered from the most recent result 530 to the oldest result 510 and the most recent result values are stored in said array in the first position of the array and the oldest result value of the second result generator is stored in the last or Mth position of the array.

When the player enters the game the first time or changes the coin value stored in memory 216, the ordered array in memory 216 is cleared represented in the graphical interface by the fact that the conveyor belt is empty. The conveyor belt is made up of five positions, located directly above the five reels, wherein each position of the conveyor belt is associated to the reel below it, which is the graphical representation of values in the ordered array to columns in the first result. The graphical interface also displays an egg dispenser 590. When the player plays the first spin, the egg dispenser will either put an egg or not put an egg on the first position 530. Every time the player makes a new spin (without changing the coin value) the conveyor belt moves one position to the left and the behavior described above is repeated. Thus for each spin the player will have 0-5 eggs on the conveyor belt.

The second result generator 220 can generate different predetermined win values represented by different types of eggs:
Coin wins (fix coin win printed on the egg)
Spreading wilds
Free spins
Swapping symbols
Changing symbols
Surprise egg (with any of the features above)

The feature is triggered every time a wild value is generated in a column of the first result, represented by the graphical interface of said user input/output device 215 as a wild symbol 570 on a reel, at the same time as there is a value of said updated array associated to said column, e.g. represented by the egg in position 530 and the wild symbol in the column below 570, that equals one of said predetermined win values, represented by the graphical interface of said user input/output device 215 as an egg above the reel. The graphical interface of said user input/output device 215 will then animate the egg will falling down (removed) from the conveyor belt and land on the wild symbol.

The winnings values or rewards activated from the eggs will be added in case several eggs are won. Free spins are only triggered from the free spin eggs. Any coin win generated by the feature is added to the total win on the spin.

During free spins the slot machine will put out an egg for each new spin. Free spins will start with eggs present, or predetermined win values present in said ordered array, above all reels except the leftmost 510, i.e. the last value of said ordered array. The distribution of these eggs will be drawn from the free spin egg distribution. When the player returns to the base game, the egg distribution from previous base game state is restored.

### Optimization of Winnings Values and the “Spreading Swapping Symbols” Feature

In accordance with an embodiment, the first result is presented as game graphics in the user input/output device 21 that comprises a number of symbols, of which one is referred to as an “wild” symbol. In accordance with embodiments, the identified position 340 corresponds to the position of a “wild” value or symbol. In an embodiment, one main feature of the game is the swapping symbols feature. Each time a user requests a spin, or in other words plays the game, a spin is generated. In an embodiment, a spin results in a graphical representation of the generated result matrix, obtained from the result generator 212. The graphical representation comprises game symbols placed on the different positions of the matrix.

The bonus game is performed if a value of the updated array associated with a column where a “wild symbol” appears equals a predefined result value representing “changing symbols”.

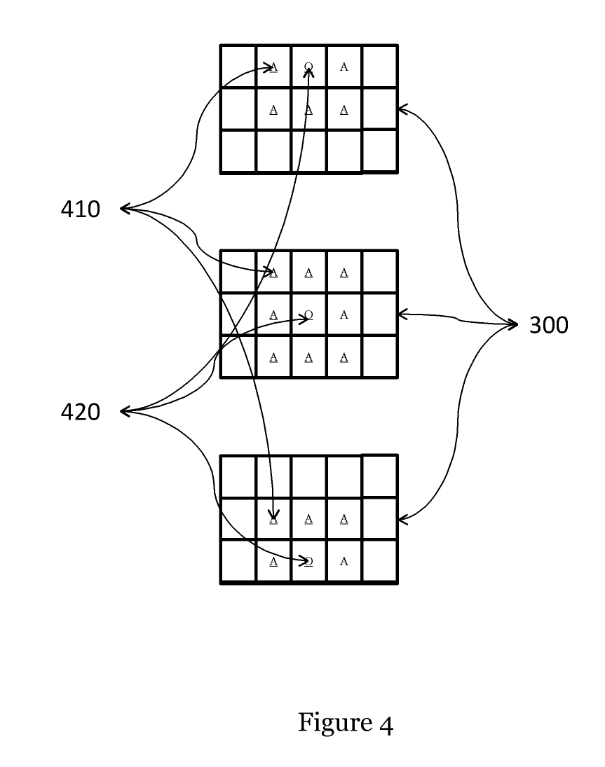

The position of the “wild” symbol is the basis for providing the ability to swap positions of other symbols in the matrix, according to method embodiments presented herein. A swap may be performed as long as the symbols are located on matrix cells adjacent to the cell on which the “wild” symbol is located, as described further in connection with FIG. 4. Such a swap is performed in order to optimize the winnings result of the game, in accordance with the method embodiments presented herein.

Each base spin has a certain chance of a “wild” symbol result. In embodiments, each position has an equal probability.

When the reels have stopped, the position if the “wild” determined and the associated value of the updated array equals “changing symbols”, the “wild” symbol will try to swap the position of two symbols, according to embodiments presented herein.

In one embodiment, the matrix is graphically represented as e.g. a video slot with an optional number of bet lines (fixed), featuring a base game and a free-spin mode.

The “wild” can reach all adjacent positions (not counting its own position). This is illustrated in the matrices 300 of FIG. 4, wherein the cell comprising an wild symbol is labeled 420 and marked with an “o” and cells adjacent to a cell 420 are labeled 410 and marked with an “a”. In the example embodiments of FIG. 4, the matrices are 5×3 matrices. However, as is understood by someone skilled in the art, methods described herein may be adapted to fit a matrix having any suitable number of rows and columns, without going beyond the scope of the inventive concept.

In the first matrix shown in FIG. 4, there are 28 possible swaps. In the second and third matrices, there are 10 possible swaps.

In one example, the game controller 212 creates the highest possible win for the player by swapping the positions of two symbols adjacent to the determined position 340.

In accordance with embodiments, if a swap is identified that enhances the winning value, the swap is performed and an enhanced final winning value is used. If the winnings value enhancing module does not find a suitable swap it remains active until a new result has been obtained. New results are generated until a swap opportunity occurs.

A swap is carried out as follow:
1. Calculate the original winnings value for the spin.
2. Calculate what the win would be for all possible swaps of two symbols adjacent to the “wild” symbol.
3. If the win for the best possible swap is higher than the original win, the best swap is carried out and the win is awarded.
4. If the win for the best possible swap is the same as the original win, the win is awarded.

### Example Game Round

1. Reel outcome is generated
2. The wild symbol is randomized to the bottom position.
3. The game shows:
   4 4 S 6 Q
   6 J Q J T
   3 K O 7 7
4. Current win is o and all swaps yield a win of o as well. Perform re-spin.
5. Reel outcome is (23, 45, 15, 59, 125).
6. The game shows:
   6 Q T 6 J
   3 7 Q J T
   J T O 7 A
7. Current win is o. The swap, marked with underlined symbols, yields a win of 12. The swap is performed and the win is awarded.

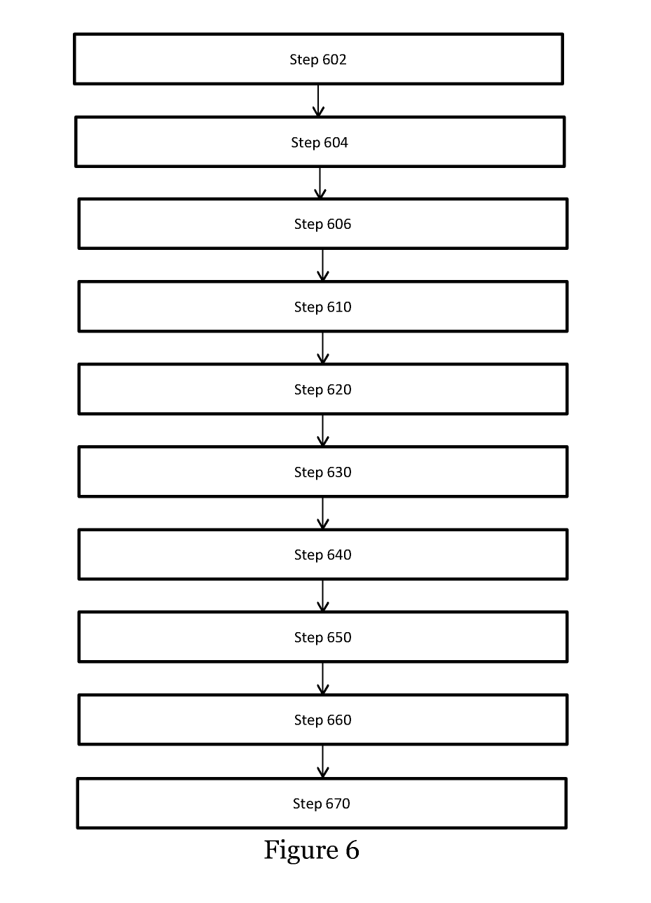

FIG. 6 shows a flow diagram of method embodiments wherein a “changing symbols” bonus game is performed.

In accordance with an embodiment, there is provided a method for optimizing the final winnings value of an enhanced slot machine, comprising:

In step 602: determining that said value of said updated array equals a predetermined swapping symbols value

In step 604: identifying a position in said first result, wherein at least one of said values in an associated column of said first result equals a predetermined wild value.

In step 606: Obtaining a first result.

According to embodiments, the result comprises result values 310 arranged in an N rows 320 by M columns 330 original matrix 300 of cells and an identified position 340 corresponding to a cell within said matrix.

In step 610: Determining an original winnings value.

In embodiments, the original winnings value is determined as a function of the result values in said original matrix obtained in step 606.

In step 620: Determining a subset of adjacent cells 410.

The subset of adjacent cells may be determined as being adjacent to the identified position.

In step 630: Determining all possible cell pairs within the determined subset.

In step 640: For each of said possible cell pairs:
determine a modified matrix, wherein the position of the values of the two cells comprised in the cell pair is swapped compared to their positions in the original matrix; and
determining a winnings value for said cell pair as a function of the result values of said modified matrix.

In other words, Step 640 comprises iteratively modifying the original matrix by swapping the values of all possible cell pairs of cells adjacent to the identified position and calculating the winnings value of the obtained modified matrices based on the values and positions of values of the modified matrices.

When all possible cell pairs have been processed in step 640, the method proceeds in step 650.

In step 650: Comparing all determined winnings values.

In accordance with embodiments, all determined winnings values include the original winnings value and the winnings values determined for each modified matrix in step 640.

In step 660: Determining a maximum winnings value.

In embodiments, the maximum winnings value corresponds to the highest winnings value, obtained from the comparison of all winnings values in step 650.

In step 670: Determining whether the maximum winnings value is greater than zero.

If the maximum winnings value is greater than zero step 670 comprises setting the final winnings value of the slot machine result to the maximum winnings value.

In an embodiment, the final winnings value corresponds to a winnings value determined from a modified matrix, obtained by swapping the values of two cells in a specified cell pair in the original matrix. According to this embodiment, the method further comprises: generating a graphical representation of the swapping of the two cells of the specified cell pair in the original matrix; and presenting the graphical representation of the swap to a user, using a graphical user interface.

If the maximum winnings value is not greater than zero, the previous method steps are repeated from step 602.

1. A method for optimizing the final winnings value of an enhanced slot machine, comprising:
obtaining 100 a coin value from memory 216
generating 130 a first result,
generating 140 a second result as a single value result,
determining 150 an updated array comprising M values by updating said obtained and shifted arrays first value with said single value result,
determining 160 a winnings value based on said coin value, said first result and said updated array

2. The method of claim 1, further comprising:
obtaining 110 the available latest previous successive results of the second result generator from memory 216 as an ordered array of length M, wherein said array is ordered with the most recent value first and the Mth value last,
shifting 120 values of the obtained array one step, thereby discarding the Mth value,
, wherein said first result comprises result values 310 arranged in an N rows 320 by M columns 330 original matrix 300 of cells,

3. The method of claim 1, wherein obtaining a coin value further comprises:
determining that the obtained coin value is different than in the previous game round and clearing the values of previous successive results of the second result generator in said updated array from memory.

4. The method of claim 1, wherein determining a winnings value further comprises:
determine that a bonus game should be performed based on said first result and said updated array, wherein determine that a bonus game should be performed is based on the comparison of each value of said updated array to values in an associated column of said first result, wherein said association is exclusive and one to one; and;
determine an original winnings value based on said first result.
if it is determined that a bonus game should be performed then perform a bonus game;

5. The method of claim 4, wherein performing a bonus game comprises:
determine that said value of said updated array equals a predetermined coin win value;
determine that at least one of said values in an associated column of said first result equals a predetermined wild value; and
determine a winnings value as a sum of said original winnings value and a predetermined winnings value associated to said coin win value.

6. The method of claim 4, wherein performing a bonus game comprises:
store said current first result and said current updated array to memory 216 as an original result;
determine that said value of said updated array equals a predetermined free spin value;
determine that at least one of said values in an associated column of said first result equals a predetermined wild value;
successively perform the method steps of obtaining a coin value from memory 216, obtaining the latest previous successive results of the second result generator from memory 216 as an ordered array of length M, shifting values of the obtained array one step, generating a first result, generating a second result as a single value result, determining an updated array by updating said obtained and shifted arrays first value with said single value result and determining a winnings value based on said coin value, said first result and said updated array and determining a winnings value based on said coin value, said first result and said updated array a predetermined number of times;
determine a winnings value as the sum of said original winnings value and said successively determined winnings values; and;
restore the current result by retrieving said original result from memory.

7. The method of claim 4, wherein performing a bonus game comprises:
determine that said value of said updated array equals a predetermined swapping symbols value;
identify a position 340 in said first result, wherein at least one of said values in an associated column of said first result equals a predetermined wild value;
determine a subset of adjacent cells 410 as being adjacent to said identified position in said first result and to determine all possible cell pairs within said subset; and for each of said possible cell pairs:
determine a modified matrix, wherein the position of the values of the two cells comprised in the cell pair is swapped compared to their positions in the original matrix; determine a winnings value for said cell pair as a function of the values of said modified matrix;
comparing all determined winnings values, wherein all determined winnings values include the original winnings value and the winnings values determined for each modified matrix; determining a maximum winnings value corresponding to the highest winnings value from said comparison of all winnings values;
determining whether the maximum winnings value is greater than zero; and
if the maximum winnings value is greater than zero,
set the final winnings value of the slot machine result to the maximum winnings value; else;
repeat the previous method steps of claims 1, 4 and 7

8. The method of claim 4, wherein performing a bonus game comprises:
In one or more embodiments, wherein performing a bonus game comprises:
determine that said value of said updated array equals a predetermined spreading wilds value
identify a position 340 in said first result, wherein at least one of said values in an associated column of said first result equals a predetermined wild value;
determine a subset of adjacent cells 410 as being adjacent to said identified position in said first result
setting the value of said subset of adjacent cells 410 to said predetermined wild symbol value to obtain a modified first result;
determine a winnings value based on said modified first result.

9. The method of claim 4, wherein performing a bonus game comprises:
determine that said value of said updated array equals a predetermined changing symbols value;
identify a position 340 in said first result, wherein at least one of said values in an associated column of said first result equals a predetermined wild value.
determining an original winnings value based on the values of said first result;
determine a subset of adjacent cells 410 as being adjacent to said identified position in said first result and determine all possible permutations within said subset; and for each of said possible permutations,
determine a modified matrix, wherein the permutated values of the cells comprised in subset of adjacent cells is changed compared to their positions in the original matrix,
determine a winnings value based on said modified matrix;
comparing all determined winnings values, wherein all determined winnings values include the original winnings value and the winnings values determined for each modified matrix; select a winnings value from said comparison of all winnings values;
determining whether the selected winnings value is greater than zero; and
if the selected winnings value is greater than zero, set the final winnings value of the slot machine result to the winnings value;

10. The method of claim 4, wherein performing a bonus game comprises:
determine that said value of said updated array equals a predetermined surprise win value;
determine that at least one of said values in an associated column of said first result equals a predetermined wild value;
determine a winnings value by randomly performing a selection of one of the set of steps comprised in claim 5, 6, 7, 8 or 9.

11. A System for optimizing the final winnings value of an enhanced slot machine, comprising:
a game controller 212, e.g. a processor or processing unit;
a first result generator 219
a memory 216 adapted to store and retrieve program code portions, parameters and historical or previous results of the second result generator
a communications interface 217 configured to send or receive data values or parameters to/from a game controller 212 to/from external units via the communications interface 217;
a winnings value generator 221 adapted to determine a result based on a parameter describing a betting value and the result of the first result generator;
a user input/output device 215 adapted to receive data as a signal from the game controller 212 and display a representation of said data and to receive user indications as data and send said indications as a signal to the game controller 212;
wherein said game controller 212 is provided with specifically designed programming or program code portions adapted to control the processing unit to perform the method steps of claims 1-8

12. The system of claim 9, wherein said first result generator 219 is adapted to generate a multidimensional value (M columns and N rows) slot machine result and said second result generator 220 adapted to generate a single value result.

13. The system of claim 9, wherein result for the M previous results of the second result generator is stored in memory 216.

14. The system of claim 9, wherein said winnings value generator 221 is further adapted to determine a winnings value based on the result of the second result generator.

15. The system of claim 9, wherein said winnings value generator 221 may be an integral part of the game controller 212, external to the game controller inside the system or external to the system and communicating via an external communications interface with the game controller 212.

16. The system of claim 9, wherein said game controller 212 is communicatively coupled to said user input/output device 215, said memory 216, communications interface 217, said first result generator 219 and said second result generator 220;
